(19) United States
(12) Patent Application Publication
(10) Pub. No.: US 2020/0296893 A1
(43) Pub. Date: Sep. 24, 2020

(54) LAWNMOWER SYSTEMS AND DEVICES INCLUDING A LEAF BLOWER ATTACHMENT

(71) Applicant: JEWGENT, INC., Sarasota, FL (US)

(72) Inventor: Lonnie BOHRER, Sarasota, FL (US)

(73) Assignee: JEWGENT, INC., Sarasota, FL (US)

(21) Appl. No.: 16/817,710

(22) Filed: Mar. 13, 2020

Related U.S. Application Data
(60) Provisional application No. 62/821,552, filed on Mar. 21, 2019.

(51) Int. Cl. A01D 43/00; A01G 20/47; B08B 5/02

(52) U.S. Cl. CPC A01D 43/00; B08B 5/02; A01G 20/47

(57) ABSTRACT

A system including a lawnmower and an attachment for a lawnmower that is configured for releasably coupling a handheld leaf blower to a riding lawnmower including a tube having a first end and a second end, the first end including a receptacle configured to releasably secure an airflow end of the handheld leaf blower to the tube; and an outlet member disposed at the second end of the tube and including at least one outlet to direct air from the outlet, the outlet member including at least one fastener for securing the outlet member to the riding lawnmower. At least one nozzle may be secured to the at least one outlet of the outlet member and may direct airflow from the tube along an adjustable and repositionable orientation relative to a longitudinally extending axis of the at least one outlet.

### CROSS-REFERENCE TO RELATED APPLICATIONS

The present disclosure relates to and claims the benefit or and priority to U.S. Prov. Pat. App. Ser. No. 62/821,552, which was filed on Mar. 21, 2019, the entire contents of which are hereby incorporated by reference.

### BACKGROUND OF THE INVENTION

### Field of the Invention

The present disclosure generally relates to an attachment for a lawnmower, and more particularly to an attachment for a lawnmower for releasably coupling a leaf blower to the lawnmower.

### Description of the Related Art

As shown in FIGS. 1A-1B, a gardener G using a leaf blower 10 is shown. Conventionally, a leaf blower 10 includes a housing containing a motor that is configured to eject or blow air out from a tube 11 such that the air A flowing out therefrom moves leaves and other debris away and generally in the direction of the airflow, i.e., along the longitudinal axis B-B defined by the tube 11. The leaf blower 10 may be handheld as shown in FIG. 1A or alternatively, the leaf blower 10 may be worn as a backpack as shown in FIG. 1B.

Conventionally, the direction in which the air blown from the leaf blower 10 flows depends on how the person holds the leaf blower 10 and how the user stands as this determines the orientation of the axis B-B that is defined by the tube 11 of the leaf blower 10. In other words, the gardener G must direct his or her body in the direction that he or she wishes to have the airflow of leaf blower 10 directed towards such that the gardener G is not free to perform other tasks besides leaf blowing while using the leaf blower 10.

While attachments for leaf blowers may be known (see, e.g., U.S. Pat. No. 7,065,944), attachments for lawnmowers such that conventional leaf blowers can be used are not known in the art and would be particularly advantageous so as to more efficiently blow and collect leaves and other debris from lawns and gardens.

Also, while riding mowers including leaf blowers are known such as those disclosed in U.S. Pat. No. 8,579,058 and U.S. Pat. Pub. No. 2014/0157744, such systems have disadvantages. For example, there are applications in which a handheld leaf blower is desirable. It should be appreciated, however, that having a specialized tool for each particular application may be cumbersome and impractical. For example, for large lawns, a riding mower is desirable and conventionally, a gardener may periodically dismount the riding mower and use a handheld leaf blower to clean up leaves and debris (e.g., grass trimmings).

From a time-efficiency and convenience standpoint, it would be desirable if such a handheld leaf blower could be used while riding the mower and that the airflow from the leaf blower could be optimally directed while using the riding mower. As discussed above, conventional riding mowers, even those that have leaf blowing functionality, are unable to optimally direct or redirect airflow from leaf blowers and cannot safely be operated while using a conventional handheld leaf blower.

The presently disclosure addresses the above discussed disadvantages of the conventional art.

### ASPECTS AND SUMMARY OF THE INVENTION

An attachment for releasably coupling a handheld leaf blower to a riding lawnmower including a tube having a first end and a second end, the first end including a receptacle configured to releasably secure an airflow end of the handheld leaf blower to the tube; and an outlet member disposed at the second end of the tube and including at least one outlet to direct air from the outlet, the outlet member including at least one fastener for securing the outlet member to the riding lawnmower.

The at least one outlet may include at least a first outlet and a second outlet, i.e., at least two outlets. At least one nozzle may be secured to the at least one outlet of the outlet member and may direct airflow from the tube along an adjustable and repositionable orientation relative to a longitudinally extending axis of the at least one outlet. A first nozzle having a first longitudinally extending axis may be securable to the first outlet and may be radially adjustable relative to first longitudinally extending axis. A second nozzle having a second longitudinally extending axis may be securable to the second outlet and may be radially adjustable relative to the second longitudinally extending axis. The first nozzle and the second nozzle may be independently adjustable relative to one another.

A lawnmower system may include a lawnmower; and a tube having an inlet configured to receive an outlet end of a handheld leaf blower and at least one outlet configured to direct airflow from the handheld leaf blower in at least one of a direction in a forward direction and a lateral direction with respect to a direction of operation of the lawnmower.

These and other aspects of the present disclosure are more fully described hereinbelow with reference to the accompanying figures.

### BRIEF DESCRIPTION OF THE DRAWINGS

A further understanding of the present disclosure can be obtained by reference to a preferred embodiment set forth in the illustrations of the accompanying drawings. Although the illustrated preferred embodiment is merely exemplary of methods, structures and compositions for carrying out the present disclosure, both the organization and method of the disclosure, in general, together with further objectives and advantages thereof, may be more easily understood by reference to the drawings and the following description. The drawings are not intended to limit the scope of this disclosure, which is set forth with particularity in the claims as appended or as subsequently amended, but merely to clarify and exemplify the disclosure.

For a more complete understanding of the present disclosure, reference is now made to the following drawings in which:

FIGS. 1A-1B are illustrations showing the use of a conventional leaf blower as known in the prior art.

FIG. 2 is a perspective view a leaf blower attachment for a lawnmower in accordance with an embodiment of the present disclosure.

FIG. 3 is a perspective view of the leaf blower attachment of FIG. 2 shown mounted and coupled to a riding/standing lawnmower and in use according to the present disclosure.

FIG. 4 is a perspective view of a further embodiment of a leaf blower attachment for a lawnmower in accordance with present disclosure.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale.

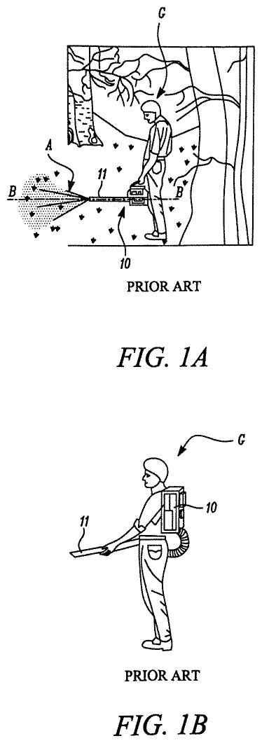

As discussed above, and as shown in FIG. 1, a gardener G using a conventional leaf blower 10 is shown. Conventionally, a leaf blower 10 includes a housing containing a motor that is configured to eject or blow air out from a tube 11 such that the air A flowing out therefrom moves leaves and other debris away and generally in the direction of the airflow, i.e., along the longitudinal axis B-B defined by the tube 11. Therefore, conventionally, the direction in which the air flows depends on how the person holds the leaf blower 10 and how the person stands as this determines the orientation of the axis B-B that is defined by the tube 11 of the leaf blower 10. The present disclosure addresses overcomes at least some of the limitations of the conventional leaf blower by enabling gardeners to ride on their lawnmowers while also leafblowing, thereby increasing efficiency and speed.

It should also be appreciated that using such a conventional leaf blower 10 while performing other tasks, e.g., riding a lawn mower may be difficult, dangerous, and/or impossible as controlling the lawnmower often involves the use of both hands (e.g., one hand to steer left/right and a second hand to control speed) and it is also important for an operator to remain alert with an eye in the direction in which the lawnmower is traveling. Conventionally, this means that once completing lawnmower operations, that the operator needs to take his handheld leaf blower to clean-up leaves and debris created from trimming the lawn.

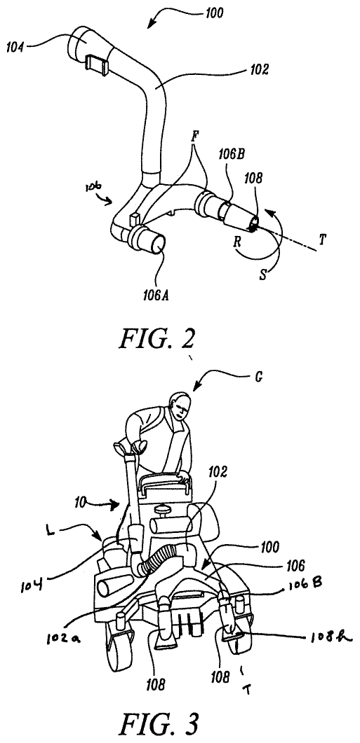

Advantageously, the present disclosure provides an attachment 100 for a conventional lawnmower which is now described with reference to FIGS. 2 and 3.

As shown in FIG. 2, the attachment 100 includes a tube 102 which may be configured in a shape which facilitates mounting of the attachment 100 onto a conventional lawnmower at an appropriate position while facilitating releasably coupling a handheld leaf blower thereto such that operation of both the leaf blower and the lawnmower can take place contemporaneously. The tube 102 may have any suitable shape including, for example, an L-shape, which may be coupled to one or more outlets for air.

As will be discussed in greater detail below, the attachment 100 may be secured to the lawnmower. For example, some or all of the components (e.g., the tube 102) of the attachment 100 may be secured to the frame or housing of the lawnmower.

The attachment 100 allows a user to operate the lawnmower and the leaf blower at the same time, i.e., the leaf blower can be used while on a standing or riding lawnmower by coupling the leaf blower to the attachment 100. In particular, the leaf blower may be coupled to the attachment 100 and may be placed in an actuated or ‘on’ mode and secured to the attachment 100 such that while controlling the lawnmower, the leaf blower also works to blow leaves and debris.

As shown in FIG. 3, the tube 102 may be secured to a lawnmower L. Also, as shown in FIG. 3, a flexible member 102a may be disposed between an inlet end of the attachment 100 and the tube 102. Securing of a leaf blower to the attachment 100 may be accomplished by providing a leaf blower, such as the leaf blower 10 and inserting the tube 11 into an inlet 104 of the tube 102. The inlet 104 may be configured, e.g., shaped and sized, to snuggly receive the tube 11 of the leaf blower 10 such that the tube 11 remains secured within the inlet 104 of the tube 102 of the attachment 100 until it is removed by the operator, e.g., gardener G and the risk of inadvertent removal is minimized. For example, the inlet end 104 may be formed from or may include a compressible or semi-compressible material to facilitate forming a seal around the end of the leaf blower that is inserted into the inlet end 104.

The tube 102 may include or may be coupled to an outlet member 106 through which airflow from the leaf blower is directed. The tube 102 and the outlet member 106 may be integrally formed or may be discrete components that are secured to one another. The outlet member 106 may include one or more outlets 106A and 106B. When used, air flowing out from the tube 11 of the leaf blower 10 may pass through the tube 102 and through the outlet member, exiting from and through the outlets 106A and 106B.

As shown in FIG. 2, nozzles 108 may be coupled or secured to each of the outlets 106A and 106B. The nozzles 108 may have a tapered shape that narrows from where it is secured to the outlets 106A and 106B toward its distal or outlet end such that the air is directed toward a narrowed end, thereby increasing the rate of the airflow and the intensity with which the air exists from the nozzles 108. In addition, the nozzles 108 may be configured to swivel or rotate, e.g., in any direction along or against directional arrows R and S such that airflow along the longitudinally extending axis T of the nozzle 108. While the longitudinally extending axis of the nozzle 108 may be co-axial with the longitudinally extending axis of the outlet 106A or 106B to which it is attached, the axis T of the nozzle 108 may be angled in any direction relative to the longitudinally extending axis of the outlet 106A or 106B. The nozzles 108 may be adjustable to adjust the rate of airflow through the nozzles 108, e.g., by adjusting an aperture of the nozzles 108 through which air is directed. As shown in FIG. 3, nozzles 108 may include a tapered head 108h, which may have an elongated shape, and/or may be rotated relative to longitudinally extending axis T, which may facilitate directed air to a surface beneath the lawnmower L.

As shown best in FIG. 3, the outlet member 106 may include fasteners F, e.g., nuts or bolts (FIG. 2), which may be used to secure the outlet member 106 to the housing of a lawnmower L, which may be a conventional standing riding mower. During use, the leaf blower 10 may be coupled to the tube 102 at its inlet end 104, thereby enabling the operator or gardener G to operate both the lawnmower L and the leaf blower 10. As the nozzles 108 are selectably directable, the nozzles 108 may be oriented such that airflow from the leaf blower 10 blows air in the direction of travel of the lawnmower L or in directions orthogonal thereto; additionally, the nozzles 108 may direct air in different directions from one another. It should be appreciated that while two nozzles 108 are shown coupled to an equal number of outlets 106A-B that a greater or lesser number of such nozzles 108 and outlets 106A and 106B may be utilized.

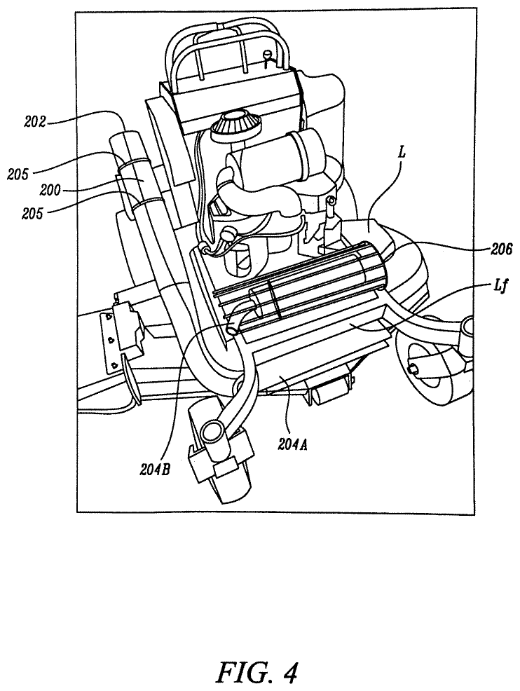

In a further embodiment, as shown in FIG. 4, an attachment 200 that is substantially similar to the attachment 100 may be coupled to the lawnmower L. The attachment 200 may include an inlet end 202 into which the leaf blower 10 may be inserted and coupled. The first outlet member 204A may be secured at a front end of the lawnmower frame Lf to direct airflow toward the front of the lawnmower L. A second outlet member 206 having at least one outlet end 204B that may be secured to an opposing surface of the lawnmower frame Lf.

The attachment 200 may include at least a first outlet member 204A and may be secured to the lawnmower L with one or more rings 205 that are disposed at or near the inlet end 202 that are secured to the lawnmower L. The second outlet member 206 may be in fluidic communication with the inlet end 202 may be configured to direct airflow from the leaf blower 10, when it is coupled to the attachment 200 at its inlet end 202, to a lateral side of the lawnmower L. The inlet end 202 may include a gasket or the like to form a fluidic seal with the leaf blower when it is inserted into the inlet end 202. Thus, the outlet 204A may direct airflow toward the front of the lawnmower L and the outlet 204B may direct airflow to the side of the lawnmower L at the same time. The outlet 204A may include a narrowed, elongated opening such that a relatively strong stream of airflow is directed toward the front of the lawnmower L.

### GLOSSARY OF TERMS

G: Gardener
L: Lawnmower
Lf: Lawnmower frame
10: Leaf blower
11: Tube
B-B: Longitudinal axis defined by the tube 11
100: Attachment
102: Tube
102a: Flexible member
104: Inlet
106: Outlet member
106A: Outlet
106B: Outlet
108: Nozzle
108h: Nozzle head
F: Fastener
200: Attachment
202: Inlet
204A: First outlet member
204B: Second outlet member
206: Attachment means

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. An attachment for releasably coupling a handheld leaf blower to a lawnmower, comprising:
a tube having a first end and a second end, the first end including a receptacle configured to releasably secure an airflow end of the handheld leaf blower to the tube; and
an outlet member disposed at the second end of the tube and including at least one outlet to direct air from the outlet, the outlet member including at least one fastener for securing the outlet member to the riding lawnmower.

2. The attachment for releasably coupling a handheld leaf blower to a riding lawnmower of claim 1, further comprising:
at least one nozzle, the at least one nozzle being securable to the at least one outlet of the outlet member.

3. The attachment releasably coupling a handheld leaf blower to a riding lawnmower of claim 2, wherein:
the at least one nozzle directs airflow from the tube along an adjustable and repositionable orientation relative to a longitudinally extending axis of the at least one outlet.

4. The attachment for releasably coupling a handheld leaf blower to a riding lawnmower of claim 1, wherein:
the at least one outlet includes at least a first outlet and a second outlet.

5. The attachment for releasably coupling a handheld leaf blower to a riding lawnmower of claim 4, further comprising:
a first nozzle having a first longitudinally extending axis, the first nozzle being secured to the first outlet, the first nozzle being radially adjustable relative to first longitudinally extending axis; and
a second nozzle having a second longitudinally extending axis, the second nozzle being secured to the second outlet, the second nozzle being radially adjustable relative to the second longitudinally extending axis,
wherein the first nozzle and the second nozzle are independently adjustable relative to one another.

6. The attachment for releasably coupling a handheld leaf blower to a riding lawnmower of claim 1, wherein:
the at least one outlet includes at least a first outlet directed toward a forward end of the riding lawnmower and at least a second outlet directed toward a lateral side of the riding lawnmower.

7. A lawnmower system, comprising:
a lawnmower; and
an attachment for releasably coupling a handheld leaf blower to the lawnmower, the attachment comprising:
a tube having a first end and a second end, the first end including a receptacle configured to releasably secure an airflow end of the handheld leaf blower to the tube; and
an outlet member disposed at the second end of the tube and including at least one outlet to direct air from the outlet, the outlet member including at least one fastener for securing the outlet member to the riding lawnmower.

8. The lawnmower system of claim 7, further comprising:
at least one nozzle, the at least one nozzle being securable to the at least one outlet of the outlet member.

9. The lawnmower system of claim 8, wherein:
the at least one nozzle directs airflow from the tube along an adjustable and repositionable orientation relative to a longitudinally extending axis of the at least one outlet.

10. The lawnmower system of claim 7, wherein:
the at least one outlet includes at least a first outlet and a second outlet.

11. The lawnmower system of claim 7, further comprising:
a first nozzle having a first longitudinally extending axis, the first nozzle being secured to the first outlet, the first nozzle being radially adjustable relative to first longitudinally extending axis; and
a second nozzle having a second longitudinally extending axis, the second nozzle being secured to the second outlet, the second nozzle being radially adjustable relative to the second longitudinally extending axis,
wherein the first nozzle and the second nozzle are independently adjustable relative to one another.

12. The attachment for releasably coupling a handheld leaf blower to a riding lawnmower of claim 7, wherein:
the at least one outlet includes at least a first outlet directed toward a forward end of the riding lawnmower and at least a second outlet directed toward a lateral side of the riding lawnmower.
